(19) United States
(12) Patent Application Publication
(10) Pub. No.: US 2007/0188327 A1
(43) Pub. Date: Aug. 16, 2007

(54) Radio frequency device

(75) Inventors: Mark E. Keeton, Kettering, OH (US); Mohamed Fayaz S. Khatri, Kettering, OH (US); Wendell B. Halbrook, JR., Waynesville, OH (US); Yaoping A. Tan, Lebanon, OH (US)

Correspondence Address: Adam Bennett;Intellectual Property Section, Law Department, NCR Corporation, 1700 South Patterson Blvd., Dayton, OH, 45479-0001, US

(73) Assignee: NCR Corporation

(21) Appl. No.: 11/355,571

(22) Filed: Feb. 16, 2006

(51) Int. Cl. G08B 13/14

(52) U.S. Cl. 340/572.7; 340/572.5

(57) ABSTRACT

A tunable radio frequency identification device and a method for customizing a radio frequency identification device are disclosed. The method for customizing the radio frequency identification device includes: providing a radio frequency identification device having a tunable antenna; and modifying the tunable antenna. As a result of modifying the antenna the inlay is tuned to operate within one of several frequencies bands.

### BACKGROUND

The present invention relates generally to a wireless communications device, and, more particularly, to a radio frequency device.

Wireless communications devices, including wireless memory devices for storing and retrieving data such as radio frequency identification (“RFID”) transponders, are generally known in the art. One common type of RFID transponder is an RFID tag.

A typical RFID tag comprises an inlay packaged in such a way that it can be attached to an object, such as an article of commerce. The inlay further comprises an integrated circuit coupled to an antenna, both of which are mounted on a substrate. The integrated circuit can receive and transmit radio frequency signals via the antenna. The resonant frequency of the antenna is dictated by the mass and shape of the conductive material that comprises the antenna.

RFID technology is used around the world in many diverse industries; however, the frequency at which RFID tags must operate is dictated by an assortment of regional, governmental, and standards bodies. For instance, North America allows operation under the UHF frequencies of 902-928 MHz, while European RFID devices must operate at a frequency between 865-868 MHZ. Thus an RFID tag built for the United States cannot effectively operate in Europe and vice versa. As a result of this, a different inlay design must be manufactured for each region to meet the different frequency requirement of each region.

### SUMMARY

It is among the objects of one or more embodiments of the present invention to provide a tunable RFID inlay.

According to a first aspect of the present invention there is provided a method of customizing a radio frequency identification device, the method comprising: providing a radio frequency identification device having a tunable antenna; and modifying the tunable antenna thereby tuning the antenna to a selected frequency, where the selected frequency is within one of a plurality of different frequency bands.

In some embodiments, modifying the tunable antenna may include removing one or more portions of the antenna. These one or more portions of the antenna may be removed according to a pattern. The pattern may be selected from a plurality of patterns, wherein the selected pattern corresponds to one of the plurality of different frequency bands. Removing the one or more portions of the antenna may further include cutting the pattern into the antenna.

In some embodiments, modifying the tunable antenna may include altering the mass and shape of the tunable antenna. Altering the mass and shape of the antenna may be accomplished by electronically connecting conductive material to the antenna, by removing a portion of the tunable antenna, or a combination of both.

According to a second aspect of the present invention there is provided a method of adjusting the resonant frequency of a radio-frequency device so that the radio-frequency device operates in one of a plurality of different frequency bands. This method includes: providing an inlay having an antenna disposed in a first antenna pattern; modifying the first antenna pattern to a second antenna pattern, thereby tuning the inlay to operate at a selected frequency; and wherein the selected frequency is within one of a plurality of different frequency bands.

In some embodiments, the first antenna pattern is configured to tune the antenna to an original frequency, where in the original frequency is with in one of the plurality of different frequency bands.

According to a third aspect of the present invention there is provided a method of modifying an RFID inlay. The method including: providing an inlay having a tunable antenna configured in a first pattern; selecting a second pattern; and removing a portion of tunable antenna according to the second pattern, thereby tuning the antenna to a selected frequency, where the selected frequency is within one of a plurality of different frequency bands.

According to a fourth aspect of the present invention there is provided a radio frequency device comprising: a substrate; and an tunable antenna disposed on the substrate and configured in a first pattern, wherein the first pattern is modifiable into a second pattern.

In some embodiments, the radio frequency device further includes an integrated circuit electronically coupled to the antenna.

In some embodiments, the antenna is operable within a first frequency band when configured in the first pattern and is operable within a second frequency band when configured in the second pattern.

In some embodiments, the radio frequency device is modifiable into a second pattern by removing a portion of the antenna. In others, it is modifiable into a second pattern by adding conductive material to the antenna.

In some embodiments, the radio frequency device has break-away lines pre-cut into the antenna of the inlay according to the second patter; and wherein the first pattern is selectably modifiable into the second pattern by removing a portion of the antenna along the break-away lines.

According to a fifth aspect of the present invention there is provided a method of modifying a generic inlay to meet a standard within a particular region. The method includes: producing a generic inlay; determining the frequency required by the particular region; and modifying the generic inlay so that it operates at the required frequency.

According to a sixth aspect of the present invention there is provided a method of converting a RFID inlay which is operable a first frequency to a RFID label which is operable at a second frequency. The method includes: providing a generic RFID inlay which operable the first frequency; modifying the generic RFID inlay, wherein the generic RFID inlay in tuned to the second frequency; and incorporating the RFID inlay into a label.

### BRIEF DESCRIPTION OF THE DRAWINGS

Benefits and advantages of the present invention will become apparent to those skilled in the art to which this invention relates from the subsequent description of example embodiments and the appended claims, taken in conjunction with the accompanying drawings, in which:

FIG. 1 is a plan view of a generic radio frequency device (in the form of an RFID inlay) in accordance with an embodiment of the present invention;

FIG. 2A shows a radio frequency device similar to that of FIG. 1, after being modified to operate within a first frequency band;

FIG. 2B shows another radio frequency device similar to that of FIG. 1, after being modified to operate within a second frequency band;

FIG. 3 shows an RFID label which incorporates the radio frequency device of FIG. 2A;

FIG. 4 is a plan view of a generic radio frequency device (in the form of a RFID inlay) according to a further embodiment of the present invention;

FIG. 5A shows a radio frequency device similar to that of FIG. 4, after being modified to operate within the first frequency band; and

FIG. 5B shows another radio frequency device similar to that of FIG. 4, after being modified to operate within the second frequency band.

### DETAILED DESCRIPTION

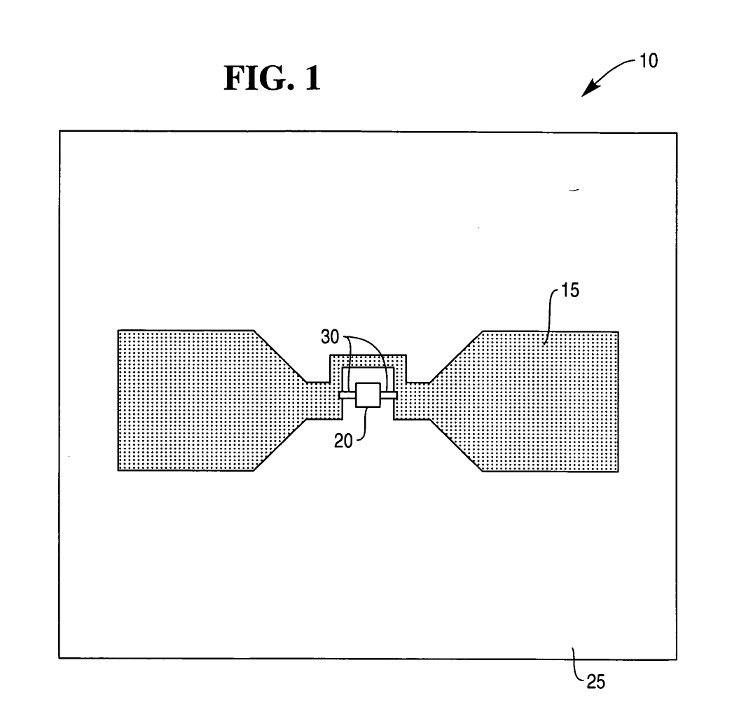

FIG. 1 shows a radio frequency device 10, in the form of a RFID inlay, according to one embodiment of the present invention. The RFID inlay 10 includes an antenna 15 applied to a substrate 25, and electronically coupled to an integrated circuit 20 via an interposer 30 (such as a strap) or any other suitable connector. The antenna 15 may comprise a solid piece of metal; alternatively, a conductive ink or conductive adhesive may be used to form the antenna 15 (as disclosed in U.S. patent application entitled “A Radio Frequency Device” filed by the NCR, Corp. on Dec. 8, 2005 and having an application Ser. No. 11/297,705). Based on the material used for the antenna 15 and the intended use of the RFID inlay 10, a suitable substrate is selected, such as polyester or paper, having an appropriate thickness, such as one mil (approximately 25.4 microns).

As already stated, the resonant frequency of the antenna 15 is dictated by the mass, shape, and type of the conductive material that comprises the antenna 15. Initially, the antenna 15 is configured in a generic shape, as illustrated in FIG. 1. In a subsequent manufacturing or processing step, the generic shape is altered to tune the antenna 15 to a desired frequency. The specific way that the shape is changed is by removing portions of the antenna 15 according to a predetermined pattern, thereby changing both the mass and the shape of the antenna 15.

It will be appreciated that using a generic shape of antenna 15 allows the RFID inlay 10 to be tuned to operate in any one of several frequency bands at some time after the inlay 10 has been manufactured.

The predetermined pattern is selected based on the geographic region the RFID inlay 10 is intended to operate in.

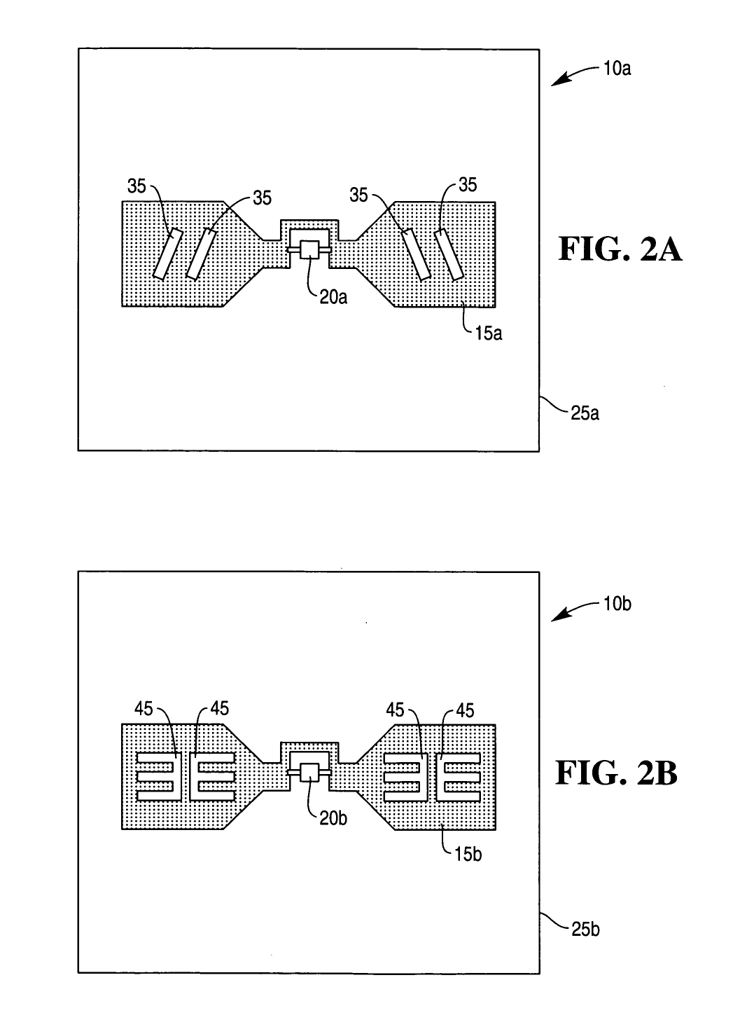

Reference will now be made to FIG. 2A then FIG. 2B to illustrate how the generic shape of the antenna 15 has been altered to be tuned to either the European frequency band or the North American frequency band.

FIG. 2A shows an inlay 10a (which is initially identical to inlay 10 of FIG. 1) after a European Pattern has been applied to remove material from the antenna 15a, thereby tuning the antenna 15a to operate in the frequency band 865-868 MHZ, as required in Europe. After the European Pattern has been applied, the antenna 15a defines apertures 35 as shown in FIG. 2A. The pattern may be applied to the antenna 15a using any suitable technique, for example a punch press or die-cutting device may be used, or a laser cutting or ablation tool may be used.

FIG. 2B shows another inlay 10b (which is initially identical to inlay 10 of FIG. 1) having portions of its antenna 15b removed according to a North American Pattern, thereby tuning the inlay 10b to operate in the frequency band of 902-928 MHz, as required in North America. After the North American Pattern has been applied, the antenna 15b defines apertures 45 as shown in FIG. 2B.

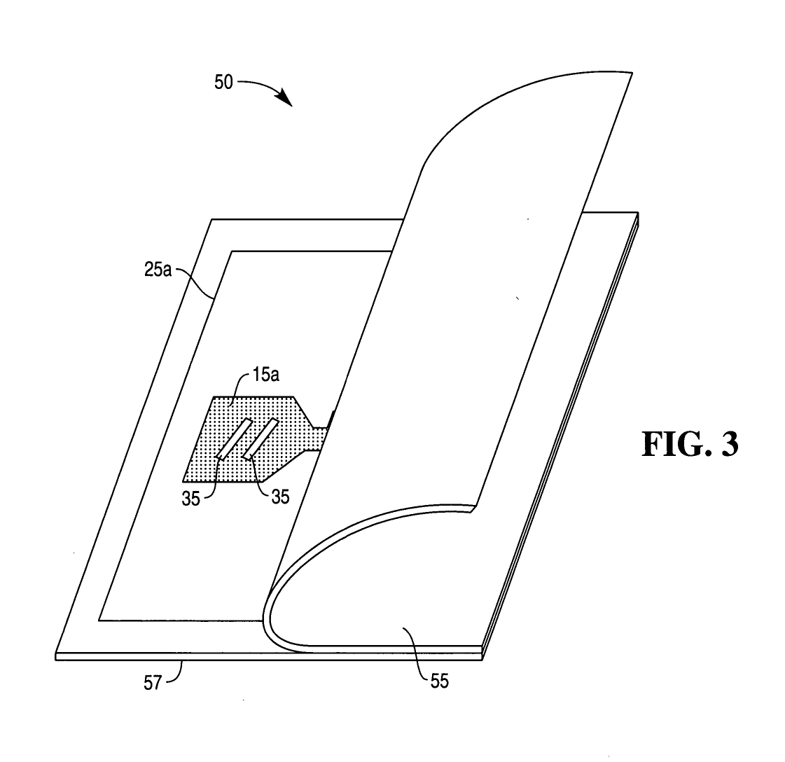

Typically, the RFID inlay 10a or 10b will be converted into an RFID label 50, as shown in FIG. 3 (for inlay 10a). The RFID label 50 includes the inlay 10a mounted between a facestock 55 and a release liner 57. The inlay 10a is aggressively adhered to facestock 55 and releasably adhered to release liner 57, so that that the inlay 10a together with the facestock 55 can be peeled from the release liner 57 as a single unit and applied to an object, such as an article of commerce.

It will be appreciated, that the RFID inlay 10 may be altered at any point during the RFID label converting process, however, it may be convenient to first tune the inlay 10 and then insert it into the two-ply label, rather than inserting the inlay 10 prior to tuning the inlay 10.

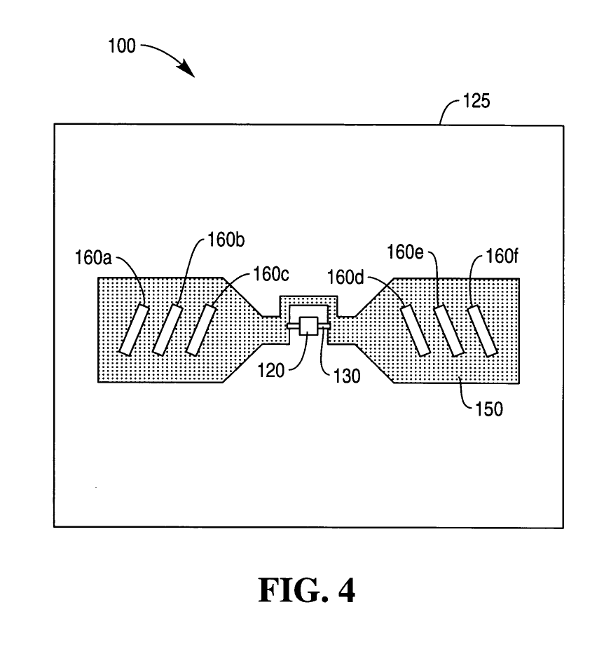

FIG. 4 shows an alternative embodiment of the present invention in the form of generic inlay 100. Like the inlay 10, the inlay 100 includes an antenna 150 applied to a substrate 125, and electronically coupled to an integrated circuit 120 via an interposer 130 or other suitable connector. Similarly, at the time the inlay 100 is manufactured, the antenna 150 is configured in a generic shape, as illustrated in FIG. 4, and can subsequently be tuned to a desired frequency by altering the generic shape of the antenna 150. However, unlike the inlay 10, the inlay 100 is tunable by adding conductive material to the antenna 150, as opposed to removing it, thereby increasing the mass of the antenna 150 and changing its shape.

It will be appreciated that using a generic shape of the antenna 150 allows the RFID inlay 100 to be tuned to operate in any one of several frequency bands at some time after the inlay 100 has been manufactured.

In this embodiment, the antenna 150 is formed from conductive ink which is printed onto the substrate 125. Unlike, the antenna 15, the generic shape of the antenna 150 includes a generic pattern in the form of slots 160_{a-f}. The conductive ink defines these slots 160, i.e. the slots 160 are not imprinted with conductive ink. Any suitable printer may be used to print the antenna 150, such as a thermal transfer printer, ink jet printer, laser printer or such like.

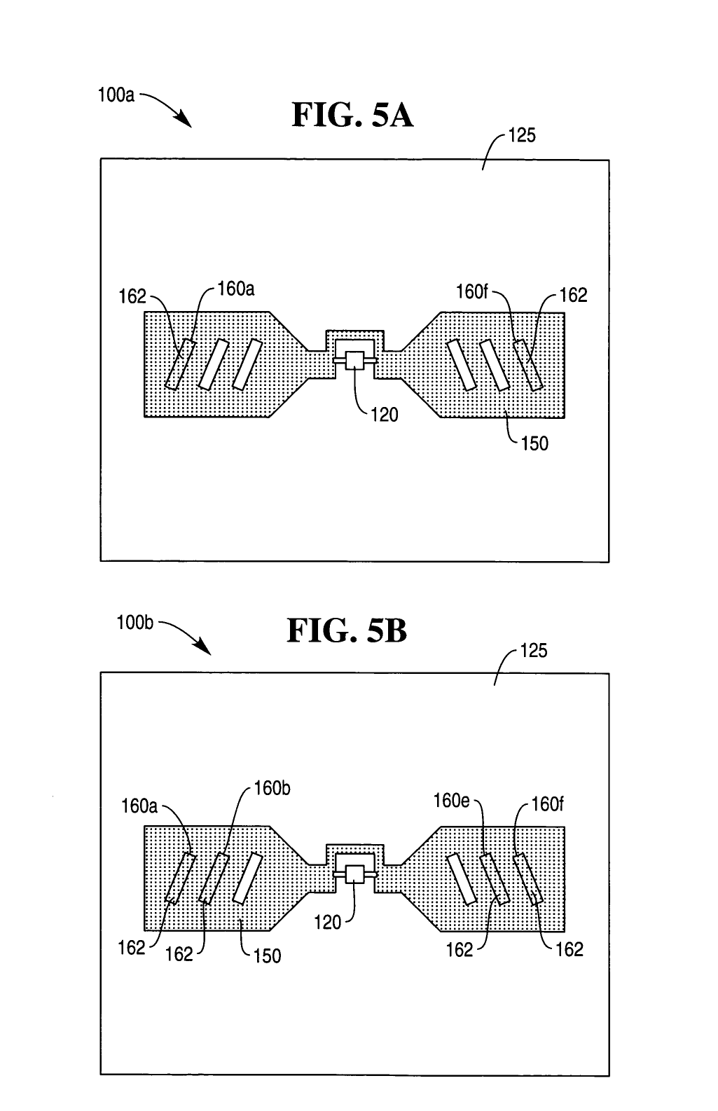

After the inlay 100 has been manufactured, typically at the start of the RFID label converting process, the inlay 100 is tuned to a desired resonant frequency by filling in one or more slots with a conductive ink 162 or any other suitable conductive material. For example, FIG. 5A shows inlay 100a with the conductive ink 162 filled into the slots 160ₐ and 160_{f}, and FIG. 5B shows inlay 100b with the conductive ink 162 filled into the slots 160_{a-b} and 160_{e-f}. Once filled into the slots the conductive ink 162 becomes part of the antenna 150, thereby changing its mass and shape. The inlay 100 is then converted into an RFID label using conventional methods.

It should be appreciated that FIGS. 5A and 5B show inlays tuned to operate in the frequency bands as required by Europe and the United States, respectively.

It will also be appreciated that the tunable aspect of the present invention reduces the amount of processing needed to create inlays for different regions, as a single inlay design can be produced for use in diverse geographic regions, where in the past a different inlay design had to be produced for each region.

Various modifications may be made to the above described embodiments, within the scope of the present invention.

For example, in the embodiments described above the antenna was tunable either by adding conductive material or removing conductive material from the antenna. However, it will be appreciated that using both of these methods on a single antenna is within the scope of the present invention.

In some embodiments, the antenna of the inlay may be pre-processed with break-away lines to facilitate easier removal of a portion of the antenna. For example, without removing a portion of the antenna, the antenna may be scored, perforated, die-cut or punched with break-away lines according to one or more patterns. An antenna may include narrow portions linking wider areas so that the narrow portions can be cut or ablated, thereby ensuring that only a tiny amount of material needs to be removed to make a large change to the mass and shape of the antenna. It will be appreciated that this pre-processing may allow portions of the antenna to be removed with less agitation to the fragile electrical connections between the integrated circuit and the antenna. This pre-processing may also facilitate easier and/or less expensive tuning of the inlay in a particular geographic region

In still other embodiments, the inlay is tuned by inserting the inlay into a label that has conductive elements to which the antenna of the inlay is electronically connected during the label converting process. It will be appreciated that these conductive elements increase the mass and shape of the antenna thereby tuning the inlay to a desired resonant frequency.

Although the above embodiments illustrate a specific pattern for each of the European and North American inlays, different patterns (geometrical configurations) than those illustrated may be applied to tune the inlay to the same frequencies.

Although the above embodiments all include a bowtie shape for the generic antenna, a generic antenna may have any other convenient shape.

1. A method of customizing a radio frequency identification device, the method comprising:
providing a radio frequency identification device having a tunable antenna; and
modifying the tunable antenna thereby tuning the antenna to a selected frequency, where the selected frequency is within one of a plurality of different frequency bands.

2. The method of claim 1, wherein modifying the tunable antenna includes removing one or more portions of the antenna.

3. The method of claim 2 wherein the one or more portions of the tunable antenna is removed according to a pattern.

4. the method of claim 3, wherein the pattern is selected from a plurality of patterns, wherein the selected pattern corresponds to one of the plurality of different frequency bands.

5. The method of claim 3, wherein modifying the tunable antenna further includes cutting the pattern into the antenna.

6. The method of claim 1, wherein modifying the tunable antenna includes altering the mass and shape of the tunable antenna.

7. The method of claim 6, wherein altering the mass and shape of the antenna further includes electronically connecting conductive material to the antenna.

8. The method of claim 6, wherein altering the mass and shape of the antenna further includes removing a portion of the tunable antenna.

9. A method of adjusting the resonant frequency of a radio-frequency device so that the radio-frequency device operates in one of a plurality of different frequency bands, the method comprising:
providing an inlay having an antenna disposed in a first antenna pattern;
modifying the first antenna pattern to a second antenna pattern, thereby tuning the inlay to operate at a selected frequency; and
wherein the selected frequency is within one of a plurality of different frequency bands.

10. A method according to claim 9, wherein the first antenna pattern is configured to tune the antenna to an original frequency, where in the original frequency is with in one of the plurality of different frequency bands.

11. A method of modifying an RFID inlay, the method comprising:
providing an inlay having a tunable antenna configured in a first pattern;
selecting a second pattern; and
removing a portion of tunable antenna according to the second pattern, thereby tuning the antenna to a selected frequency, where the selected frequency is within one of a plurality of different frequency bands.

12. A radio frequency device comprising:
a substrate; and
an tunable antenna disposed on the substrate and configured in a first pattern, wherein the first pattern is modifiable into a second pattern.

13. The radio frequency device according to claim 12, further comprising an integrated circuit electronically coupled to the antenna.

14. The radio frequency device according to claim 12 wherein the antenna is operable within a first frequency band when configured in the first pattern and is operable within a second frequency band when configured in the second pattern.

15. The radio frequency device according to claim 12, wherein the first pattern is modifiable into a second pattern by removing a portion of the antenna.

16. The radio frequency device according to claim 12, wherein the first pattern is modifiable into a second pattern by adding conductive material to the antenna.

17. The radio frequency device according to claim 12, wherein break-away lines are pre-cut into the antenna of the inlay according to the second patter; and wherein the first pattern is selectably modifiable into the second pattern by removing a portion of the antenna along the break-away lines.
